(19) United States
(12) Patent Application Publication
(10) Pub. No.: US 2026/0145172 A1
(43) Pub. Date: May 28, 2026

(54) WASTE POUCH FOR BIOLOGICAL WASTE, SUCH AS IMMUNOASSAY WASTE

(71) Applicant: Radiometer Medical ApS, Brønshøj (DK)

(72) Inventors: Esbjørn SCHROLL, Brønshøj (DK); Tsz Lok Keith TANG, Brønshøj (DK)

(21) Appl. No.: 19/121,190

(22) PCT Filed: Nov. 23, 2023
(86) PCT No.: PCT/EP2023/082802

§ 371 Date: Apr. 15, 2025

(30) Foreign Application Priority Data
Nov. 25, 2022 (EP) 22209607.5

(51) Int. Cl. B01L 3/00

(52) U.S. Cl. CPC B01L 3/505; B01L 2200/0684; B01L 2300/069; B01L 2400/0605

(57) ABSTRACT

A waste pouch for biological waste from a blood analyser device is provided, as well as a cassette comprising said waste pouch, and a blood analyser device comprising said pouch or said cassette. The pouch comprises an envelope, a vent in the upper surface of the envelope for outlet of gas, and an opening for receiving liquid and gaseous waste. The pouch comprises a superabsorbent polymer contained in the envelope, said superabsorbent polymer being in the form of beads.

### TECHNICAL FIELD

The present invention provides a waste pouch for biological waste from a blood analyser device, as well as a cassette comprising said waste pouch, and a blood analyser device comprising said pouch or said cassette. The pouch comprises an envelope, a vent in the upper surface of the envelope for outlet of gas, and an opening for receiving liquid and gaseous waste. The pouch comprises a superabsorbent polymer contained in the envelope, said superabsorbent polymer being in the form of beads.

### BACKGROUND

Blood analysis machines are used widely in the medical field to analyze various properties in human blood. (For convenience, the term “blood analyzer” will be used throughout this description to refer to blood analysis machines. It should be recognized, however, that the present invention is not intended to be limited to blood analyzers and can be used in urine, mucous, spinal fluid, and sperm analysis machines.) A blood sample is taken from a patient, and the blood is transferred into the blood analyzer. The blood analyzer is then used to determine the levels of particular components (e.g., blood gases and electrolytes) found within the blood.

When the blood analyzer has finished analyzing a blood sample, the waste blood is transferred to a waste container. Liquids are used in the blood analyser, to perform assays, to calibrate the analyser and to flush the blood analyzer after a blood sample has been analyzed. These liquids are also transferred to the waste container. Gases are also used to flush the blood analyser, and are also transferred to the waste container.

Thus, a significant amount of liquid and gas may be transferred to the waste container. If not handled properly, the liquid and gas may spill or leak, or cause “ballooning” in the waste container. The waste container should be able to manage the waste liquid and gas. It should also be disposable and replaceable in a hygienic manner, and comply with hazardous waste regulations. Blood and blood components may also clot, even after being analysed, increasing the risk of blockage of the inlet and/or outlet of a waste container.

Known waste containers comprise an open tray of moulded plastic, and may not be sufficient to avoid spillages and leakages. Other known solutions include waste bags which stand upright in a device, which is undesirable from the point of view of liquid flow and replaceability of the waste bag. A waste bag for a portable blood analyzer is described in WO9743988A1. Another device facilitating waste disposal is described in WO2016096845.

Therefore, a need exists for a waste container for a portable blood analyzer that is disposable, lightweight, and compact, and that can manage large amounts of liquid and gas while substantially preventing spilling and/or leaking of waste fluids. Importantly, the waste container should effectively allow gases to vent, avoiding blockages, while effectively retaining waste liquids. The present invention aims to provide such a waste container.

### SUMMARY

It has been found by the present inventor(s) that effective waste containment, and effective gas venting in a waste pouch for a blood analyser can be achieved, while avoiding blockage or clogging of the gas vent and the waste inlet opening. A waste pouch for biological waste from a blood analyser device is thus provided,
said pouch comprising an envelope formed of a liquid and gas impermeable film material,
said envelope comprising opposing upper and lower surfaces,
said pouch further comprising a vent in the upper surface of said envelope for outlet of gas, wherein said vent is covered by a gas-permeable, liquid impermeable membrane,
said pouch further comprising an opening for receiving liquid and gaseous waste, wherein the pouch comprises a superabsorbent polymer contained in the envelope, wherein said superabsorbent polymer is in the form of beads.

A disposable cassette for a blood analyser device is also provided, said cassette comprising the waste pouch as described herein. An immunoassay analyser device is also provided, comprising the cassette as described herein or the waste pouch as described herein.

Further aspects of the invention are presented in the following figures, description text and the appended claims.

### LEGENDS TO THE FIGURES

The technology is illustrated in the enclosed schematic figures, in which:

FIG. 1 shows a perspective view of one embodiment of a waste pouch according to the invention.

FIG. 2 shows a perspective view of one embodiment of a cassette according to the invention, including a waste pouch.

FIG. 3 shows a diagram of beads of superabsorbent polymer and how they might contact a membrane.

FIG. 4 shows a picture of a full waste pouch comprising blood and assay buffer.

### DETAILED DISCLOSURE

As set out above, the invention concerns a waste pouch for biological waste from a blood joining analyser device.

Biological waste outputted from blood analyser devices is typically a mixture of blood and blood components such as plasma, various assay liquids, calibration and rinse liquids and gases. These components may enter the waste pouch in various sequences and combinations, meaning that containment of liquids and separation of gas is important.

The waste pouch comprises an envelope formed of a liquid and gas impermeable film material. In this manner, liquid and gaseous waste is handled in a hygienic manner. Typically, the maximum volume of the envelope is between 500-2000 ml, preferably between 800-1200 ml.

A skilled person knows of suitable liquid and gas impermeable film materials and techniques for forming the envelope. Suitable liquid and gas impermeable materials are polymer films, such as polyethylene (PE) or polypropylene (PP) films, which may be single-layer or multi-layer, optionally being a laminate of different layers. For maximum gas-impermeability, polymer films are suitably coated with e.g., a metallic layer. The envelope may be formed by cutting, folding, gluing, welding (e.g., heat welding) the film material as required. The construction and materials of the envelope allow the waste pouch to expand as required when in use, yet to be collapsed and/or folded together prior to use, so as to take up less space.

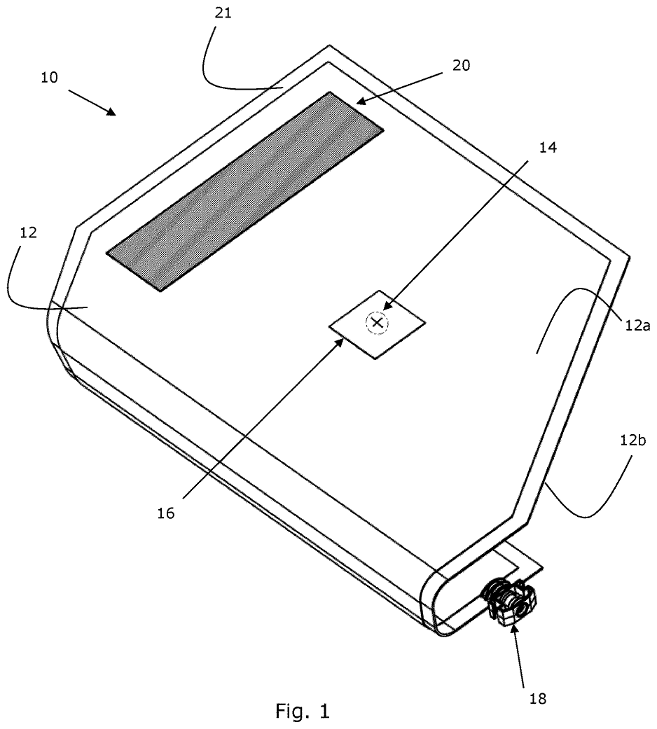

The envelope comprises opposing upper and lower surfaces. In a preferred embodiment, illustrated in FIG. 1, the envelope consists of opposing upper and lower surfaces, wherein said opposing upper and lower surfaces are sealed to each other about the respective peripheries thereof—i.e., it is formed by two pieces of film material which are joined to each other around the edges.

For ease of manufacture, it is preferred that the upper and lower surfaces of the envelope have essentially the same shape. Therefore, the envelope may have primary extension in an X-Y plane, and the upper and lower surfaces have substantially the same geometric form in said X-Y plane. The pouch further comprises an opening for receiving liquid and gaseous waste. Suitably, the opening in the pouch for liquid and gaseous waste is located in or adjacent to the seal between said upper and lower surfaces. This arrangement ensures that—as liquid and gas enter the envelope, causing it to expand—the opening becomes raised from the lower surface of the envelope. Liquid is thus encouraged to flow away from the opening, reducing the likelihood of blockage of the opening.

The opening for receiving liquid and gaseous waste may comprise a valve which is arranged to allow liquid waste to enter the envelope via said opening, while substantially preventing liquid waste from exiting the envelope via said opening. Suitably, as shown in FIG. 1, the opening may comprise one or more connecting elements, which allows the pouch to reversibly lock into corresponding elements of a waste tube in the blood analyser device, when the waste pouch is inserted into place, and unlock when the waste pouch is to be removed. Locking the connecting element(s) of the pouch opening with corresponding elements of a waste tube provides a liquid-tight connection. Suitable connecting elements may be push-fit or bayonet-type connecting elements.

Suitably, the opening for receiving liquid and gaseous waste is not located in the upper surface of said envelope. In this configuration, the vent and the opening are situated remote from one another.

Suitably, the pouch does not comprise any internal barriers or walls. In other words, it is defined solely by the upper and lower surfaces of the envelope. In particular the pouch does not comprise any internal barriers or walls arranged in the gas path between the opening and the vent, so that waste liquid and gas can flow without obstruction between said opening and said vent. This arrangement allows free distribution of waste inside the pouch.

As noted above, the pouch further comprises a vent in the upper surface of said envelope for outlet of gas. The vent is covered by a gas-permeable, liquid impermeable membrane. A suitable gas-permeable, liquid impermeable membrane is a hydrophobic membrane, such as a PTFE membrane or a fluoropolymer-treated membrane. The pouch may comprise more than one vent, each covered by a gas-permeable, liquid impermeable membrane.

TABLE 1
List of suitable membranes

| Membrane type | Supplier |
|---|---|
| (Emflon ®) PTFE membrane | Pall |
| Versapor ® RC Membranes | Pall |
| Glass Fiber Media (Hydrophobic) Membranes | Pall |

The gas-permeable, liquid impermeable membrane prevents liquid from exiting the pouch, yet can become blocked or clogged if exposed to liquid, solid and semi-solid waste. Blocking of the membrane prevents gas from exiting the pouch, which can lead to undesirable inflation of the pouch.

Preferably, the vent is located substantially in the centre of the upper surface of said envelope. The “centre” of the upper surface is defined as a point which is as far as possible from opposing edges of the upper surface, as determined in all directions. By having the vent in this location, the pouch is allowed to swell as much as possible, creating a “doming” effect, with the vent at the uppermost part.

The pouch comprises a superabsorbent polymer contained in the envelope, wherein said superabsorbent polymer is in the form of beads. Superabsorbent polymers (SAPs) are known in the field of personal hygiene products, and can absorb 200-300 times their own weight of liquid water. Suitable superabsorbent polymers may be selected from polyacrylic acid (PAA), poly(meth)acrylic acid (PMA), and esters of PAA or PMA, as well as co-polymers or block co-polymers thereof. Polyacrylamides are also suitable, either alone or as co-polymers or block co-polymers. The skilled person may select SAPs according to e.g. molecular weight or degree of crosslinking to optimise properties such as swelling.

By sequestering the liquid waste in the superabsorbent polymer, the risk of blood spillage and exposure to human material is reduced.

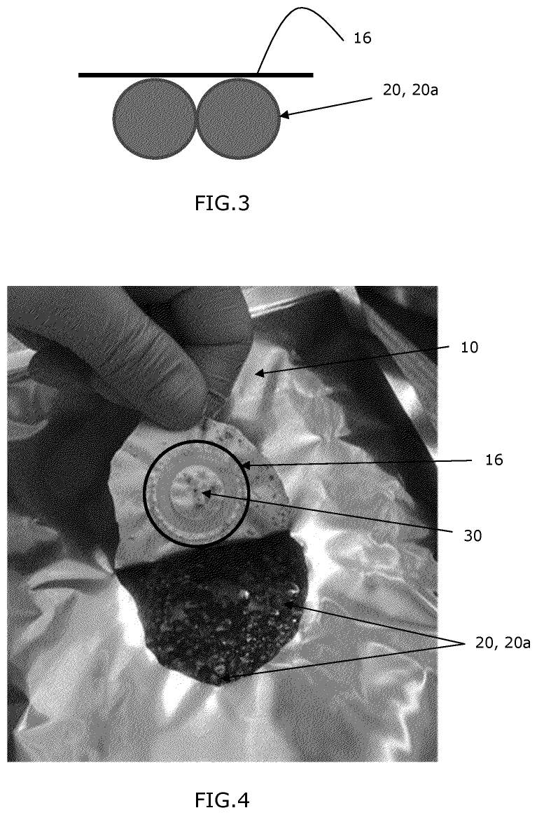

Also, in that the superabsorbent polymer is in the form of beads, the superabsorbent polymer beads can move relatively freely within the pouch, absorbing liquid as required. The superabsorbent polymer bead itself, e.g. by having a substantially spherical shape, only has a small contact area to the gas-permeable, liquid impermeable membrane. The membrane will hence not be submerged in the liquid and will therefore maintain its venting properties. This is illustrated schematically in FIG. 3.

Clumping of the superabsorbent polymer (which—in turn—can lead to blockage of the opening and/or the vent in the pouch) can thus be avoided.

The superabsorbent polymer beads have the advantage that they can move smoothly past/over each other in the pouch.

The superabsorbent polymer beads suitably have a substantially spherical shape. The superabsorbent polymer beads may have a three-dimensional geometric shape such as but not limited to spheres, hemispheres, ellipsoids, and/or volumetric polyhedrons. The beads may be a mixture of shapes. Preferably, the superabsorbent polymer beads have at least one curved surface.

This allows them to move smoothly past/over each other in the pouch, and to minimise contact area with the membrane. Suitably, in both dry and wet stage, the bead to bead surface friction and the bead to pouch surface friction is low so that the beads can easily flow and move (i.e. are free flowing) within said waste pouch, which also helps in avoiding clogging or blockage of the opening of the pouch.

Suitably, said superabsorbent polymer beads have—in the dry state—an average particle size of between 2.0-3.5 mm, preferably between 2.5-3.0 mm. A suitable supplier for SAP beads is Demi Co. Ltd.

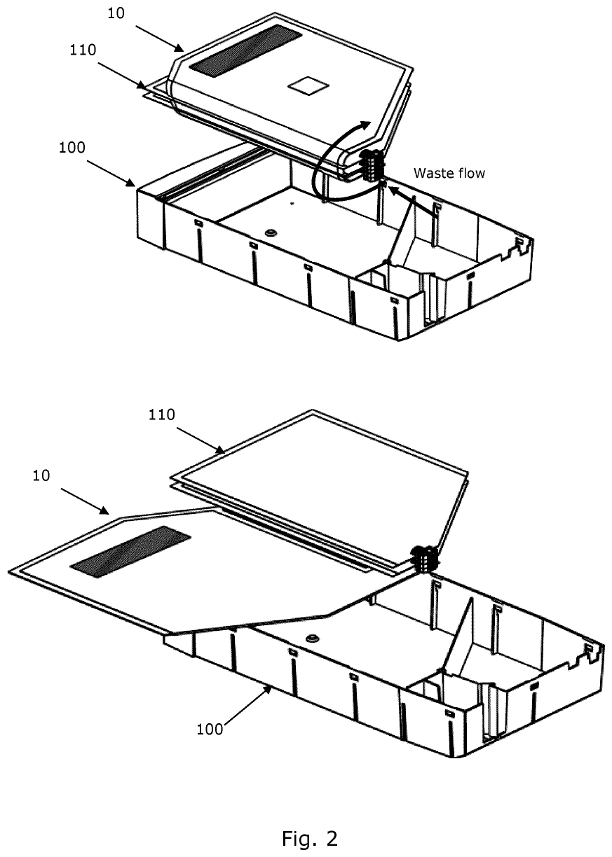

A disposable cassette for a blood analyser device is also provided, said cassette comprising the waste pouch as described herein. The cassette is illustrated schematically in FIG. 2, and has the general form of a “drawer” which is designed to be inserted into and removed from the lower portion of the blood analyzer device.

The disposable cassette may be formed as one piece of moulded plastic, or may be formed of plastic elements which are joined (welded or glued) together. The disposable cassette will typically be provided in the form of a sealed unit (i.e. base, walls and lid are joined together, so that the cassette cannot be opened without breaking it).

The comprises a substantially planar base, at least one sidewall (e.g. 2, 3, or 4 sidewalls) and a substantially planar lid, wherein said base, said at least one sidewall and said lid define a substantially closed volume comprising the waste pouch, wherein the pouch is arranged such that the vent of said waste pouch is arranged furthest from the base of the cassette.

As well as a waste pouch the cassette may further comprise one or more, and preferably two or more, and up to 9, buffer pouch(es). The buffer pouches comprise the buffer liquid required to perform the analysis in the analyzer device. The cassette thus provides buffer liquids for the analyser device. In the case where the analyzer device is an immunoassay analyser device, the buffer pouches will be assay buffer pouches. By providing the buffer pouches in the cassette, a closed system is obtained containing a buffer pouch and also a waste pouch for waste collection. This means a user should never come into direct contact with the reagents, used samples or any used reagents.

Suitably, the waste pouch has an internal volume which is equal to or greater than the total internal volume of all assay buffer pouch(es) in the cassette, so that the entirety of the assay buffer liquid can be contained in the waste pouch, once used.

In the embodiment illustrated in FIG. 2, the waste pouch is at least partly wrapped around said buffer pouch(es) in said cassette, such that a first portion of said waste pouch is located between a buffer pouch and the lid of the cassette, and a second portion of said waste pouch is located between an assay buffer pouch and the base of the cassette. The vent of the waste pouch is suitably located in the first portion of said waste pouch, and the opening of the waste pouch is suitably located in the second portion of said waste pouch. This allows the opening for liquid and gaseous waste to be located lowermost in the cassette, i.e. closest to the base, while the vent can be located uppermost. In one aspect, the blood analyser device is an immunoassay analyser device. The invention thus provides an immunoassay analyser device comprising the cassette as defined herein, or the waste pouch as defined herein.

### DESCRIPTION OF THE FIGURES

FIG. 1 shows a schematic, perspective view of the waste pouch (10) according to the invention. The pouch (10) comprises an envelope (12) of a liquid and gas impermeable film material. As shown, the envelope (12) comprises opposing upper (12a) and lower (12b) surfaces, joined to each other via a seal (21), i.e. a sealed edge. In the embodiment of FIG. 1, only upper and lower surfaces are present. Vent (14) is located in the upper surface of the envelope, and is covered by a gas-permeable, liquid impermeable membrane (16). Opening (18) is arranged for receiving liquid and gaseous waste into the pouch (10). The pouch comprises a superabsorbent polymer (20) contained in the envelope, in the form of beads. The waste pouch (10) of FIG. 1 is illustrated in a folded configuration, ready to be contained within a cassette (100).

FIG. 2 shows a cassette (100) according to the invention (shown without the lid, for clarity purposes). The upper figure in FIG. 2 shows how the waste pouch (10) is folded about buffer pouch(es) (110); in this case two buffer pouches (110) are shown. The lower figure in FIG. 2 shows the unfolded configuration, showing how the waste pouch (10) “wraps around” the buffer pouches (110).

FIG. 3 shows a hypothetical image of how beads of superabsorbent polymer (20) create space between each other and the gas-permeable, liquid impermeable membrane (16). Gas can thus pass through passages which are present between individual beads and between the beads and the membrane.

FIG. 4 shows a photo of a full waste pouch (10) with the liquid impermeable membrane (16) and the beads of superabsorbent polymer (20, 20a) comprising blood and assay buffer. The small spots (30) on the inside of the membrane (16, disk welded to the pouch) indicates minimal blockage. In this way, the photo shows that this membrane (16) still has ample venting capacity.

### EXAMPLES

### Bead Size Test:

### Test Protocol

1. Transparent folded waste pouches were assembled with Super Absorbent Polymer beads from Demi inside and ready to be used for the test.
2. 1.2 L mixture of assay buffer and blood was prepared and injected into Assay Buffer pouches for each Solution pack in a 120 (assay buffer):1 (blood) ratio.
3. Solution packs including the folded waste pouch and assay buffer pouches were assembled and ready for the test.
4. Test Benches were setup with the following steps to test each solution pack:
   a. 4.5 mL liquid was extracted from assay buffer pouches in 4 seconds, 35 times per day and the action was continued for 7 days in total.
   b. All liquid from step (a) was injected into waste pouch with the same pace and frequency as step (a). Liquid injection was stopped when step (a) actions ended.
5. After step 4, waste pouches were taken out carefully from the solution pack with the venting membrane side facing upward. Visual inspection of the liquid absorbing material status and performance was carried out.
6. Waste pouches were placed on top of beakers while the venting membrane sides were kept facing upward.
7. A small crosscut was made at the bottom side of every tested waste pouch. The waste pouches were left for 24 hours to drain the remaining liquid.
8. After step 7, the weight of the liquid drained from the waste pouches was measured and documented.

| | Material | Test | Average weight of | |
|---|---|---|---|---|
| | weight | duration | liquid drained from | |
| Material | (g) | (days) | waste pouch (g) | Result |
| Ø2-2.5 mm | 100 | 7 | 260 | No blockage and |
| Super Absorbent | | | | venting membrane |
| Polymer beads | | | | worked properly |
| Ø2.5-3 mm | 100 | 7 | 220 | No blockage and |
| Super Absorbent | | | | venting membrane |
| Polymer beads | | | | worked properly |
| Ø3-3.5 mm | 100 | 7 | 300 | No blockage and |
| Super Absorbent | | | | venting membrane |
| Polymer beads | | | | worked properly |
| Powder from | 200 | 2 | NA | Entry port becomes |
| diapers (*) | | | | blocked. Test failed. |
| Absorption pad | 150 | 2 | NA | Entry port becomes |
| (20 cm × 20 | | | | blocked. Test failed. |
| cm × 1 cm) | | | | |

(* = granulated powder)

It can be seen that beads of superabsorbent polymer perform well compared to SAP powder and an absorption pad (such as that used in packaging of fresh meat). Blockage of the venting membrane was not observed for the SAP beads of the invention.

The present invention has been described with reference to a number of embodiments. The skilled person can combine elements from different embodiments as required. All documents cited herein are incorporated by reference.

1. A waste pouch (10) for biological waste from a blood analyser device,
said pouch (10) comprising an envelope (12) formed of a liquid and gas impermeable film material,
said envelope (12) comprising opposing upper (12a) and lower (12b) surfaces,
said pouch (10) further comprising a vent (14) in the upper surface of said envelope (12) for outlet of gas, wherein said vent (14) is covered by a gas-permeable, liquid impermeable membrane (16),
said pouch (10) further comprising an opening (18) for receiving liquid and gaseous waste,
wherein the pouch (10) comprises a superabsorbent polymer (20) contained in the envelope (12),
wherein said superabsorbent polymer is in the form of beads (20a).

2. The waste pouch (10) according to claim 1, wherein said envelope (12) consists of said opposing upper and lower surfaces (12a, 12b), wherein said opposing upper and lower surfaces (12a, 12b) are sealed to each other about the respective peripheries thereof.

3. The waste pouch (10) according to claim 2, wherein said opening (18) for liquid and gaseous waste is located in or adjacent to the seal (21) between said upper and lower surfaces (12a, 12b).

4. The waste pouch (10) according to claim 1, wherein said envelope (12) has primary extension in an X-Y plane, and wherein said upper and lower surfaces (12a, 12b) have substantially the same geometric form in said X-Y plane.

5. The waste pouch (10) according to claim 1, wherein said superabsorbent polymer beads (20a) have at least one curved surface.

6. The waste pouch (10) according to claim 1, wherein superabsorbent polymer beads (20a) have—in a dry state—an average particle size of between 2.0 mm and 3.5 mm.

7. The waste pouch (10) according to claim 1, wherein the superabsorbent polymer beads (20a) are free flowing within said waste pouch (10).

8. The waste pouch (10) according to claim 1, wherein said opening (18) for receiving liquid and gaseous waste comprises a valve which is arranged to allow liquid waste to enter the envelope via said opening (18), while substantially preventing liquid waste from exiting the envelope via said opening (18).

9. The waste pouch (10) according to claim 1, wherein said opening (18) for receiving liquid and gaseous waste is not located in the upper surface (12a) of said envelope (12).

10. The waste pouch (10) according to claim 1, wherein said vent (14) is located substantially in the centre of the upper surface (12a) of said envelope (12).

11. A disposable cassette (100) for a blood analyser device, said cassette comprising the waste pouch (10) according to claim 1.

12. The cassette (100) according to claim 11, said cassette comprising a substantially planar base, at least one sidewall and a substantially planar lid, wherein said base, said at least one sidewall and said lid define a substantially closed volume comprising the waste pouch (10), wherein the vent (14) of said waste pouch (10) is arranged furthest from the base of the cassette (100).

13. The cassette (100) according to claim 11, further comprising one or more buffer pouch(es) (110).

14. The cassette (100) according to claim 11, wherein the waste pouch (10) has an internal volume which is equal to or greater than the total internal volume of all assay buffer pouch(es) (110) in the cassette (100).

15. An immunoassay analyser device comprising the cassette (100) according to claim 10.

16. An immunoassay analyser device comprising the waste pouch (10) according to claim 1.
